(19) United States
(12) Patent Application Publication
(10) Pub. No.: US 2016/0232877 A1
(43) Pub. Date: Aug. 11, 2016

(54) FOOD CONTAINER, METHOD OF MANAGING FOOD CONTAINER, AND REFRIGERATOR

(71) Applicant: Samsung Electronics Co., Ltd., Gyeonggi-do (KR)

(72) Inventors: Tae-hyoung Cho, Seoul (KR); Soo-yeon Lee, Seoul (KR); Jae-min Lee, Incheon (KR); Eun-joo Jee, Seoul (KR); Sun-min Lee, Seoul (KR); Seon-ju Lee, Seoul (KR); Sang-woon Jeon, Seoul (KR); June-hyuck Choi, Seongnam-si (KR)

(21) Appl. No.: 15/017,289

(22) Filed: Feb. 5, 2016

(30) Foreign Application Priority Data
Feb. 5, 2015 (KR) 10-2015-0018219

(51) Int. Cl. G09G 5/12; F25D 29/00; G09G 5/00

(52) U.S. Cl. CPC G09G 5/12; G09G 5/006; F25D 29/005; G09G 2380/00; G09G 2354/00; F25D 2400/36; F25D 2700/06

(57) ABSTRACT

A food container configured to include an internal space capable of storing food is provided. The food container includes: a display unit configured to display a screen; a communication interface configured to communicate with an external apparatus for managing the food container; a controller controls information regarding the food that is synchronized with the external apparatus through the communication interface, to be displayed on the display unit.

### CROSS-REFERENCE TO RELATED APPLICATION(S) AND CLAIM OF PRIORITY

The present application is related to and claims priority under 35 U.S.C. §119 from Korean Patent Application No. 10-2015-0018219, filed on Feb. 5, 2015, in the Korean Intellectual Property Office, the disclosure of which is incorporated herein by reference in its entirety.

### TECHNICAL FIELD

The present general inventive concept generally relates to providing a food container, a method of managing the food container, and a refrigerator, and more particularly, to providing a food container that communicates with a user terminal device and displays food storage information to further easily and conveniently manage food, a method of managing the food container, and a refrigerator.

### BACKGROUND

In general, a refrigerator refers to an apparatus that keeps a storage room thereof at a low temperature to greenly store food for a long time.

Various types of food materials are stored in the storage room of the refrigerator, and users generally use general bowls or boxes used when buying food materials to store remaining food materials in refrigerators.

Also, a refrigerator is used to ferment and ripen food for a long time.

In case of food stored in the refrigerator, remaining food materials, or food stored to be ripened, a user recognizes a long-time storage of food in the refrigerator to be safe. Therefore, if time elapses, the storage of the food in the refrigerator easily fades away from a memory of the user.

Food that is forgotten by the user is neglected in the refrigerator and easily passes an expiration date or a use-by date. Therefore, the user wrongly consumes food, rebuys the same food materials, or throws away rotten food.

### SUMMARY

Exemplary embodiments address at least the above problems and/or disadvantages and other disadvantages not described above. Also, the exemplary embodiments are not required to overcome the disadvantages described above, and an exemplary embodiment may not overcome any of the problems described above.

The exemplary embodiments provide a container that communicates with a user terminal device and displays food storage information to further easily and conveniently manage food, a method of managing the food container, and a refrigerator.

To address the above-discussed deficiencies, it is a primary object to a container configured to have an internal space capable of storing food, the container including: a display unit configured to display a screen; a communication interface configured to communicate with an external apparatus for managing the food container; and a controller configured to control information which is synchronized with the external apparatus through the communication interface, to be displayed on the display unit.

The information of the food includes at least one selected from a name of the food, a picture of the food, a storage start time of the food, a period for which the food is stored in the food container, and a residual period of time set on the food container or an excess period passing the seta period of time.

The controller displays the information of the food received from the external apparatus on the display unit.

The communication interface communicates with a user terminal device, and the controller calculates a storage period of the food, displays the storage period of the food on the display unit, and transmits information about the storage period of the food to the user terminal device.

The container further includes a light emitter configured to emit light. The controller controls the light emitter to emit different colors of lights for a preset time period before and after an arrival time of the set period of time.

The container further includes a speaker configured to output a sound. The controller controls the speaker to output an alarm sound in response to the set period of time arriving.

The container further includes an input unit configured to receive a manipulation of a user. The controller controls power of the food container or initialize information of the storage period of the stored food according to a manipulation pattern input into the input unit.

The container further includes an illumination sensor configured to sense light. The controller controls power of the display unit according to whether the illumination sensor senses the light.

The container further includes: a temperature sensor configured to sense a temperature; and a duct configured to open and close an air flow path. The controller controls the duct to be opened and closed according to the sensed temperature.

The controller further displays at least one selected from information indicating a communicable state and information indicating a state where the period of time is set, on the display unit.

The container is installed as a container for storing food to be kept at a low temperature in a storage room of a refrigerator. The external apparatus is the refrigerator where the food container is installed.

The display unit is a transparent display that is a passive matrix type.

According to another aspect of the exemplary embodiments, there is provided a refrigerator including: a communicator configured to communicate with at least one food containers that are installed in the refrigerator; and a central controller configured to control the communicator to transmit information about foods stored in the at least one food containers to the at least one food containers.

The central controller calculates storage periods of the foods stored in the at least one food containers and transmit the storage periods of the foods to the at least one food containers.

The refrigerator further includes a user interface (UI). The central controller displays identification information of the at least one food containers and the information about the foods on the UI.

The communicator communicates with a user terminal device. The controller transmits the information about the foods to the user terminal device.

According to another aspect of the exemplary embodiments, there is provided a method of managing at least one food containers by using a user terminal device configured to manage the at least one food containers storing individual foods, the method including: receiving food storage-related information from the food containers or a refrigerator where the food containers are installed; and displaying food storage information of the food containers based on the received food storage-related information.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a home network system according to various embodiments of the present disclosure;

FIG. 2 illustrates a simple structure of a food container according to various embodiments of the present disclosure;

FIG. 3 illustrates a detailed structure of the food container of FIG. 2 according to various embodiments of the present disclosure;

FIG. 4 illustrates a structure of a food container according to various embodiments of the present disclosure;

FIG. 5 illustrates an operation of a food container according to various embodiments of the present disclosure;

FIG. 6 illustrates a screen that is displayed on a food container, according to various embodiments of the present disclosure;

FIG. 7 illustrates an operation of a food container according to various embodiments of the present disclosure;

FIG. 8 illustrates a structure of a user terminal device according to various embodiments of the present disclosure;

FIG. 9 illustrates a screen that is displayed on a user terminal device, according to various embodiments of the present disclosure;

FIG. 10 illustrates a method of managing a food container by using a user terminal device, according to various embodiments of the present disclosure; and

FIG. 11 illustrates a structure of a refrigerator according to various embodiments of the present disclosure.

### DETAILED DESCRIPTION

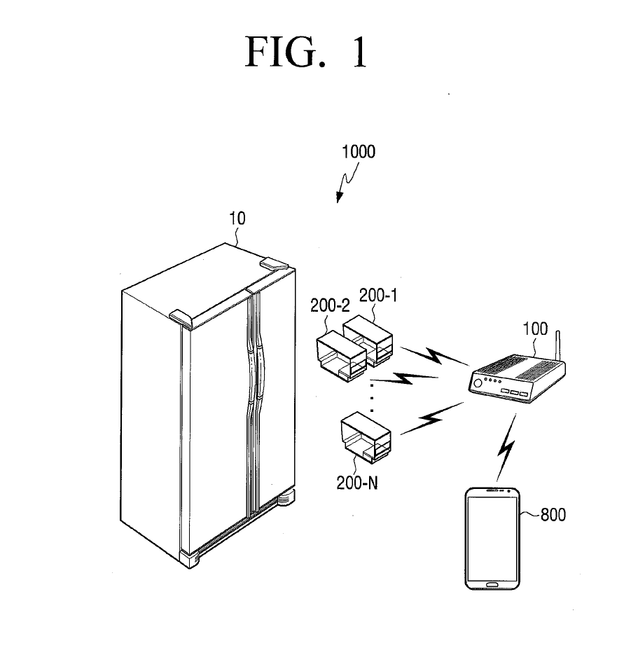

FIGS. 1 through 11, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system. Exemplary embodiments are described in greater detail with reference to the accompanying drawings.

In the following description, the same drawing reference numerals are used for the same elements even in different drawings. The matters defined in the description, such as detailed construction and elements, are provided to assist in a comprehensive understanding of the exemplary embodiments. Thus, it is apparent that the exemplary embodiments can be carried out without those specifically defined matters. Also, well-known functions or constructions are not described in detail since they would obscure the exemplary embodiments with unnecessary detail.

FIG. 1 is a view illustrating a home network system 1000 according to an exemplary embodiment of the present general inventive concept.

Referring to FIG. 1, the home network system 1000 includes a home server 100, at least one food containers 200-1, 200-2, . . . , and 200-N, and a user terminal device 800.

The home server 100 is connected to the at least one food containers 200-1, 200-2, . . . , and 200-N to communicate with the at least one food containers 200-1, 200-2, . . . , and 200-N so as to set a home network. In detail, the home server 100 is connected to the at least one food containers 200-1, 200-2, . . . , and 200-N by using a wired and wireless communicator.

Here, the home network refers to a physical network technology that enables information household appliances in a home to be connected to one another through a network so as to enable the information household appliances to be freely used regardless of time and place. Objects that constitute the home network is all types of digital products that is controlled through the Internet, such as a refrigerator, a washer, a digital TV, a camera, a computer, an air conditioner, etc. However, for convenience of description, an object of which a home network is set by using a home server will be mentioned as only a food container but is not limited thereto.

The at least one container 200-1, 200-2, . . . , and 200-N that are connected to the home server 100 go through registration and/or authentication processes through the home server 100.

For example, a communication method between the home server 100, at least one containers 200-1, 200-2, . . . , and 200-N, and the user terminal device 800 is performed according to various types of standards such as WiFi, BLUETOOTH, ZIGBEE, infrared data association (IrDA), a radio frequency (RF), etc. that all belong to the same type or different types. In other words, the containers 200-1, 200-2, . . . , and 200-N is connected to the home server 100 through WiFi, and the user terminal device 800 access the home server 100 on the Internet through a communication network such as a code division multiple access (CDMA), a wideband CDMA (WCDMA), a global system/standard for mobile communication (GSM), an evolved packet core (EPC), a long term evolution (LTE), or the like.

A container 200 is a container having an internal space for storing food. In detail, the food container 200 is an independent container that store food.

The container 200 displays information related to storage of stored food. In detail, the food container 200 provides a user with various types of information related to the storage of the food. For example, the food container 200 displays a storage period of the food from a storage start time of the food to a current time. Alternatively, the container 200 displays a remaining time to a storage deadline of the food, i.e., a residual time.

The container 200 transmits food storage information to the user terminal device 800. In detail, the container 200 transmits the food storage information to the user terminal device 800 through the home server 100 of the home network to enable the user terminal device 800 to check the food storage information.

The container 200 is installed in a refrigerator 10.

The user terminal device 800 provides the food storage information. In detail, the user terminal device 800 displays food storage information of each of the at least one container 200-1, 200-2, . . . , and 200-N to the user based on the food storage information transmitted from the container 200.

Also, the user terminal device 800 receives various types of setups for managing food. For example, the user terminal device 800 receives an input for setting an alarm to a preset deadline for managing food. In other words, the user terminal device 800 provides an interface through which the user sets an alarm to particular one of the containers 200-1, 200-2, . . . , and 200-N after a week.

The user terminal device 800 accesses the home server 100 constituting the home network. In detail, the user terminal device 800 accesses the home server 100 to read storage information corresponding to the container 200 on the home network. In certain embodiments, the access of the user terminal device 800 to the home server 100 is approved through a user authentication process and a user terminal device registration process performed between the home server 100 and the user terminal device 800.

The home network system 1000 according to the various embodiments of the present disclosure as described above uses a user terminal device, which is easily checked, to further efficiently and easily manage food without opening a refrigerator. Also, a food container that stores individual foods enables food stored in a storage room of the refrigerator to be tidily arranged and enable a user to easily check storage periods of the foods or remaining periods of the foods from storage information displayed on a front surface of the refrigerator.

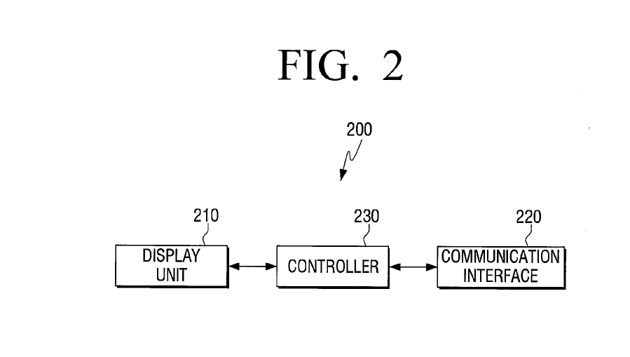

FIG. 2 is a block diagram illustrating a simple structure of the food container 200, according to various embodiments of the present genera inventive concept.

Referring to FIG. 2, the container 200 includes a display unit 210, a communication interface 220, and a controller 230.

The display unit 210 displays various types of screens for providing information to a user. In detail, the display unit 210 displays food storage information of food stored in the food container 200.

In certain embodiments, the food storage information that is displayed on the display unit 210 is one selected from a food storage period, a residual period remaining to a food storage date, and an excess period. Period information as described above is displayed as a date unit indicating a normal period of time or a normal use-by date or is variously displayed as time, minute, or second unit or the like.

At least one selected from information indicating a communicable state and information indicating a state where a period of time is set is displayed along with the storage period information on the display unit 210. In detail, the display unit 210 displays information indicating a communicable state with a user terminal device or a home server or indicating a connection state to the user terminal device or the home server. Also, if a period of time is set on the display unit 210 and a residual period and the period of time arrive, the display unit 210 displays information indicating a state of setting a function of outputting an alarm sound.

The display unit 210 is realized as a color display apparatus that displays information in various colors. The display unit 210 can also be a passive matrix type. Also, the display unit 210 is a transparent display apparatus that is disposed on a front surface of the container 200. Although the container 200 is installed in a refrigerator, the display unit 210 possesses a durability with respect to a low temperature. Also, when the user opens a door of the refrigerator to see a storage room, the display unit 210 enables the user to visibly easily check food stored in the container 200 and information about the food.

The communication interface 220 communicates with an external apparatus for managing the food container 200. In detail, the communication interface 220 communicates with the external apparatus to transmit information related to storage of food to the external apparatus and receive a signal for managing the stored food from the external apparatus.

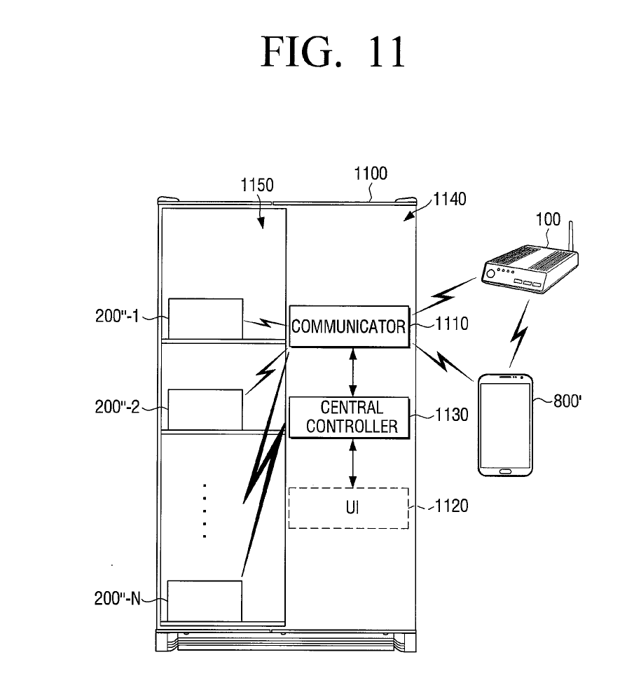

In certain embodiments, the communication interface 220 communicates with the external apparatus according to various methods. In detail, the communication interface 220 is not limited to a one-to-one direct communication to a user terminal device but communicates with the user terminal device through various types of external apparatuses. For example, as shown in FIG. 1, the communication interface 220 of the container 200 communicates with the user terminal device 800, which is a terminal connected to a wireless mobile communication network, on the Internet through the home server 100. The communication interface 220 also communicates with the refrigerator 10. This will be described in detail later with reference to FIG. 11.

The controller 230 controls a function of storing and managing elements of the container 200 and food. In detail, the controller 230 displays information about food stored in the container 200 on the display unit 210, and the information about the food synchronizes with the external apparatus.

For example, the controller 230 controls the display unit 210 to calculate and display a storage period of the food stored in the container 200. The controller 230 controls the communication interface 220 to transmit information about the storage period of the stored food to the user terminal device 800.

If information for setting a period of time is received from the user terminal device 800, the controller 230 controls the display unit 210 to display a residual period remaining to the set period of time or an excess period passing the set period of time. For this, the controller 230 performs an operation of calculating the residual period or the excess period based on set period of time information received from the user terminal device 800. For example, if a signal for determining a period of time after a week from a current date is received from the communication interface 220, the controller 230 controls the display unit 210 to display a residual period of seven days and to subtract one day from a residual period of one week as time passes and display a residual period of six days.

The controller 230 is realized as various types. For example, the controller 230 is realized as at least one selected from a processor, an application specific integrated circuit (ASIC), an embedded processor, a microprocessor, a hardware control logic, a hardware finite state machine (FSM), and a digital signal processor (DSP).

The controller 230 has been described as directly controlling elements of the container 200 to perform a function of managing storage of food but is not limited thereto. In other words, all or a part of an operation for the above-described processing of the controller 230 are entrusted to an external processor, e.g., to a control device of the refrigerator 10, to be performed by the external processor or the control device. Also, the elements of the container 200 are controlled according to a command and/or information received through the communication interface 220. A food container that is controlled by an external apparatus according to various embodiments will be described later with reference to FIG. 11.

The container 200 according to the exemplary embodiment of the present disclosure as described above provides a user terminal device with information related to storage of stored food and directly displays the information to further easily manage food.

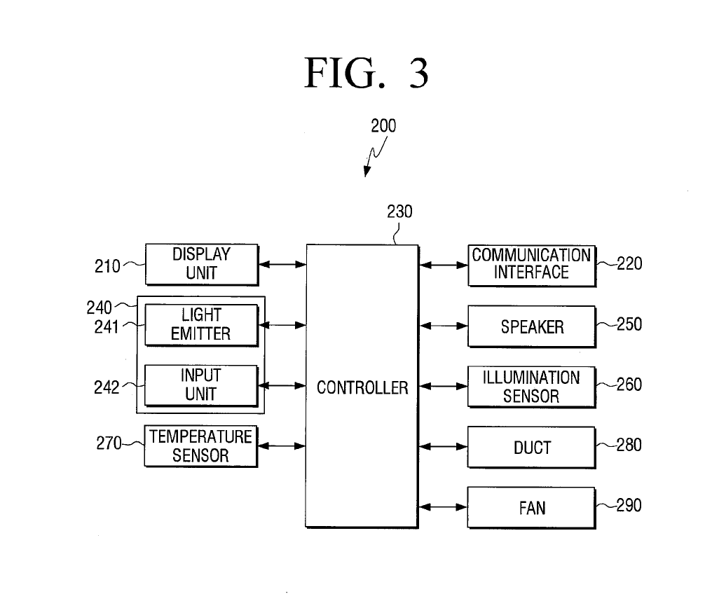

FIG. 3 is a block diagram illustrating a detailed structure of the container 200 of FIG. 2.

Referring to FIG. 3, the container 200 includes the display unit 210, the communication interface 220, the controller 230, a button unit 240 including a light emitter 241 and an input unit 242, a speaker 250, and an illumination sensor 260.

The display unit 210 displays various types of screens for providing information to the user. An operation and a function of the display unit 210 are the same as those of the display unit 210 of FIG. 2, and thus their detailed descriptions are omitted.

The communication interface 220 communicates with a user terminal device for managing the container 200. An operation and a function of the communication interface 220 are the same as those of the communication interface 220 of FIG. 2, and thus their detailed descriptions are omitted.

The light emitter 241 emits light. In detail, the light emitter 241 emits light indicating a state of the food container 200. For example, the light emitter 241 turns off light or emits light of preset color depending on a preset pattern according to a state of the container 200.

The input unit 242 receives a manipulation of the user. In detail, the input unit 242 receives manipulations of the user about various functions of the container 200 to manage food stored in the container 200.

The light emitter 241 and the input unit 242 described above are included in one button unit 240. In detail, the light emitter 241 and the input unit 242 are constituted as one button member to recognize an emission of light according to a state of the container 200 and possesses simple structures capable of inputting a user manipulation through the button member in that position.

The speaker 250 outputs a sound. In detail, the speaker 250 moves a diaphragm according to an input electric signal to generate audible range vibrations in the air.

The illumination sensor 260 senses light. In detail, the illumination sensor 260 senses that a brightness of external light is higher than or equal to a preset threshold value. For example, if the container 200 is installed in a storage room of a refrigerator, the illumination sensor 260 senses light of an illumination lamp of the storage room that is turned on or off according to opening or closing of a door of the refrigerator.

A temperature sensor 270 senses a temperature. In detail, the temperature sensor 270 senses a temperature of a space of the container 200 that stores food.

A duct 280 provides an air flow path for ventilation. In detail, the duct 280 provides a path through which external air flows into the container 200 that is a closed space. For example, the duct 280 is provided on a back surface of the container 200 and includes a structure that is opened and closed. Also, if the duct 280 is opened, the duct 280 enables cold air discharged into the storage room of the refrigerator to flow into the container 200 installed in the storage room of the refrigerator.

A fan 290 generates an air flow. In detail, the fan 290 generates an air flow of an internal space of the container 200 through electric power. For example, the fan 290 enables external cold air to flow into the container 200 through the duct 280. The fan 290 also convects flowing cold air to spread the flowing cold air in an internal space.

The controller 230 controls a function of storing and managing the elements of the container 200 and food. A function and an operation of the controller 230 are the same as those of the controller 230 of FIG. 2, and thus their repeated descriptions are omitted.

The controller 230 controls the light emitter 241 to emit light. In detail, the controller 230 controls the light emitter 241 to emit or turn off different lights in preset patterns according to a state of the container 200.

For example, if a period of time is set according to a signal received through the communication interface 220, the controller 230 controls the light emitter 241 to emit different lights for a preset time period before and after a time when the set period of time arrives, i.e., for a preset period from times before a preset period of time arrives, when the preset period of time arrives, and after the preset period of time arrives. In certain embodiments, the controller 230 controls the light emitter 241 to emit green light until two days before a period of time arrives, emit yellow light one day before the period of time arrives and emits red light from a day after the period of time arrives. The controller 230 also controls the light emitter 241 to turn off light on a date when the period of time arrives.

The controller 230 controls the speaker 250 to output a sound. In detail, if a preset event occurs in the container 200, the controller 230 controls the speaker 250 to output a sound.

For example, if a signal for a new setup is received from the user terminal device 800, the controller 230 controls the speaker 250 to output a sound corresponding to the signal. Also, if a user manipulation is received through the input unit 242, the controller 230 controls the speaker 250 to output a sound corresponding to the user manipulation. If a period of time set in the container 200 arrives, the controller 230 controls the speaker 250 to output an alarm sound for informing the user of the arrival of the period of time. In certain embodiments, if the set period of time arrives, the illumination sensor 260 senses light of an internal illumination lamp of the refrigerator, the controller 230 controls the speaker 250 to output an alarm sound. This corresponds to a state where the user approaches the refrigerator to open the door of the refrigerator, enables an unnecessary sound not to be output, and enables the user to easily find the container 200 that is deeply installed in the refrigerator and thus is unseen.

The controller 230 executes a command depending on a manipulation of the user input into the input unit 242. In detail, the controller 230 recognizes a command corresponding to a user manipulation sensed by the input unit 242 to perform a function of managing food stored in the container 200 or the like.

For example, the controller 230 turns on or off power supplied to the container 200 according to the user manipulation input into the input unit 242. Also, if a user manipulation of starting storage of food is input, the controller 230 performs a function of counting a storage period. If a user manipulation of setting a period of time is input, the controller 230 sets the period of time and perform a function of subtracting a storage period to the period of time from the period of time as time elapses. However, a function that is performed by the controller 230 as described above is entrusted to a function that is performed according to a command input through the user terminal device 800. Also, the input unit 242 is realized as a more simplified one button. In certain embodiments, the function of counting the storage period described above is realized to be automatically performed simultaneously with turning on power.

The controller 230 controls power supplied to each element of the container 200 according to whether the illumination sensor 260 senses light. In detail, if the illumination sensor 260 does not sense the light, the controller 230 cuts off a supply of power to at least one selected from the display unit 210, the communication interface 220, the light emitter 241, the input unit 242, and the speaker 250. If the illumination sensor 260 senses the light, the controller 230 supplies power to at least one selected from the display unit 210, the communication interface 220, the light emitter 241, the input unit 242, and the speaker 250 to control the display unit 210, the communication interface 220, the light emitter 241, the input unit 242, and the speaker 250 so as to respectively perform their functions. For example, if the user opens the door of the refrigerator to turn on the illumination lamp of the storage room, and the illumination sensor 260 senses this, the controller 230 supplies power to the display unit 210 to control the display unit 210 so as to display food storage-related information, etc. Alternatively, if the illumination sensor 260 senses light, the controller 230 controls to synchronize the user terminal device 800 with food storage information through the communication interface 220.

The controller 230 receives sensed temperature information from the temperature sensor 270. In detail, the controller 230 receives information about a temperature sensed by the temperature sensor 270 to perform a control for uniformly maintaining a temperature of an internal space of the container 200.

For example, after storage of food starts, and a temperature appropriate for storing food is set from information about stored food or a temperature setup for storing food is input from the user, the controller 230 monitors a temperature of a storage space of the container 200 by using the temperature sensor 270 to perform a control for maintaining a set temperature.

The controller 230 controls the duct 280 to be opened or closed. In detail, the controller 230 controls the duct 280 to be opened or closed to maintain the temperature of the internal space. For example, if a temperature sensed by the temperature sensor 270 rises from a reference temperature to a preset temperature or more, the controller 230 generates a control signal for opening the duct 280 to cool internal air. If the sensed temperature drops from the reference temperature to the preset temperature or less, the controller 230 closes the duct 280 to block an inflow of cold air from an outside.

The controller 230 controls driving of the fan 290. In detail, the controller 230 controls driving of the fan 290 to circulate air in the internal space. For example, the controller 230 operates the fan 290 to enable external cold air to flow into the internal space so as to lower the temperature of the internal space.

The duct 280 and the fan 290 have been described as being controlled to adjust the internal temperature of the container 200 but are not limited thereto. Therefore, the duct 280 and the fan 290 are controlled by turning on or off power or are controlled depending on time (e.g., a preset period).

The container 200 according to the exemplary embodiment of the present disclosure as described above provides a user terminal device with information related to storage of stored food and directly display the information so as to further easily manage the food. In addition, the container 200 enables simpler input and management through a button unit that is realized as one button member and reduces power consumption through an illumination sensor.

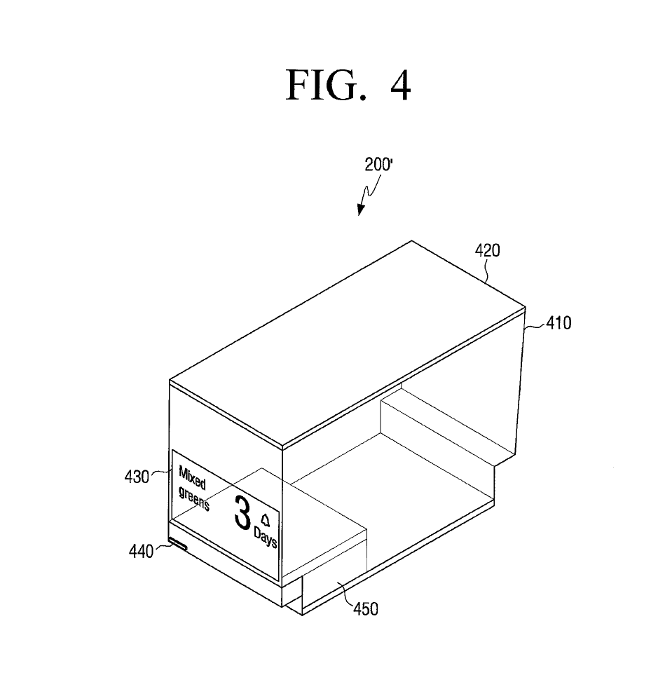

FIG. 4 is a perspective view illustrating a structure of a container 200′ according to various embodiment of the present disclosure.

Referring to FIG. 4, the container 200′ includes a case 410 of which upper part is opened, a cover 420 which covers the upper part of the case 410, a display apparatus 430, a button 440, and a computing apparatus 450.

The case 410 houses elements of the container 200′ therein and secures a space for storing food. In detail, the case 410 forms an external appearance of the container 200′, includes an internal empty space, and provides a space for taking food therein. Also, the case 410 houses the computing apparatus 450 on a side of a lower part of the case 410 to perform a food management function as described with reference to FIGS. 2 and 3.

The case 410 is formed of a material having durability with respect to impacts and heat, i.e., is formed of a plastic resin that is transparent and light. A shape of the case 410 is a wholly cubic shape as shown in FIG. 4 but is realized as various shapes according to characteristics of food or a shape of the case 410 that is installed inside a refrigerator.

The cover 420 covers the upper part of the case 410 to stably keep stored food. The case 420 is a protrusion that is formed to be fixed onto the upper part of the case 410. The cover 420 includes various types of adhering members that seals an internal part of the case 410.

The display apparatus 430 is provided on a front surface of the case 410. In detail, the display apparatus 430 is disposed on a front surface of the container 200′ so as to enable the container 200′ to be installed on a self of a storage room of the refrigerator and enable the user to easily see information displayed on the display apparatus 430.

The display apparatus 430 is realized as a transparent display apparatus so as to enable the information displayed on the display apparatus 430 and contents put in the case 410 to be checked.

Storage period information is displayed on the display apparatus 430. As shown in FIG. 4, the display apparatus 430 displays that three days elapse from a storage start date. The display apparatus 430 also displays a bell-shaped symbol indicating a state where a period of time is set.

The display apparatus 430 displays information about stored food. In detail, the display apparatus 430 displays a symbol, a food name, or a picture indicating stored food. As shown in FIG. 4, “Mixed greens” indicating stored food is displayed in an area of a screen of the display apparatus 430.

The display apparatus 430 is a passive matrix type. In detail, the display apparatus 430 constitutes a screen that will input binary signals into elements of the display apparatus 430 to display information. For example, referring to FIG. 4, “Days” and “bell shape” is respectively managed as elements to be displayed on the display apparatus 430 or to disappear from the display apparatus 430 according to only on and/or off signals. Also, a 7-segment marking method is used to turn on three horizontal strokes and two right vertical strokes and turn off other strokes on elements that are divided into 7 strokes, to display number “3”.

The display apparatus 430 is realized as a color display apparatus to display information in various colors according to a state of the container 200′ storing food so as to enable the user to be careful of an imminent period of time of the food stored in the container 200′.

The button 440 includes a light-emitting diode, which emits various colors of lights, so as to easily check a state of the container 200′ and a position of a button member. The user performs various types of inputs according to a manipulation of changing a pressed depth of the button 440, the number of times the button 440 being pressed, or a time for pressing the button 440.

The computing apparatus 450 includes an additional housing for protecting an internal part, and various types of parts and circuit boards for performing functions. In detail, the computing apparatus 450 includes a central processing unit (CPU) and a communication module for performing a period calculation, etc., a memory for storing data and an input command, etc. The computing apparatus 450 is integrated on a front surface of a lower part of the case 410 in FIG. 4 but is not limited thereto. However, the computing apparatus 450 is realized to be widely disposed over a bottom of the case 410.

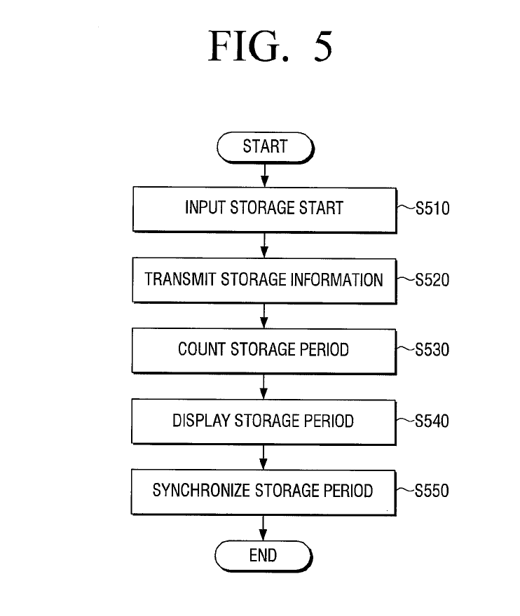

FIG. 5 is a flowchart illustrating an operation of a container, according to various embodiments of the present disclosure.

Referring to FIG. 5, in operation S510, the container receives an input for starting storage. The start of the storage is input through a button of the container by a user or is input through a signal transmitted from a user terminal device.

In operation S520, the container transmits storage information to the user terminal device. In other words, the container transmits food storage information to the user terminal device so as to enable new food to be stored in the container and enable the container storing the new food to be managed.

In operation S530, the container counts a period for which food is stored after the storage starts. In other words, the container performs an operation of accumulating a time from a start date of the storage in order to calculate the period for which the food is stored.

In operation S540, the container displays the period for which the food is stored. Before this, the container displays a result of counting the storage period through a display apparatus or the like to provide period information so as to enable the user to check the period for which the food is stored.

In operation S550, the container synchronizes information about the storage period, which is displayed to be recognized by the user and for which the food is stored, with an external apparatus so as to provide the same information as the user terminal device and/or a refrigerator.

The above-described process is not limited to the process of FIG. 5, and orders thereof are changed. Also, counting the period for which the food is stored continues until a management of food ends or is reset. If a particular event of sensing a request of the user or light of an illumination sensor occurs, the period for which the food is stored is displayed. An operation of synchronizing the storage period of the food with the user terminal device is periodically performed.

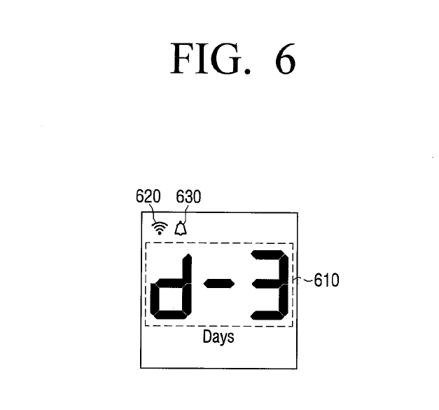

FIG. 6 is a view illustrating a screen that is displayed on a container, according to various embodiment of the present disclosure.

Referring to FIG. 6, the screen includes residual period information 610 remaining to a period of time, information 620 indicating a communicable state, and information 630 about a set alarm.

The residual period information 610 displays “d-3” through combinations of segments, which are turned on according to a passive method, to indicate that a residual period is three days.

The information 620 is provided according to whether a wireless local area network (WLAN) icon is displayed. In other words, if the WLAN icon 620 is turned on, the container is connected to a home network to indicate a communicable state.

The information 630 is provided according to whether a bell icon is displayed. In other words, if a period of time is set in the container, an alarm is scheduled, and D-day arrives, an alarm sound is output or light is turned off.

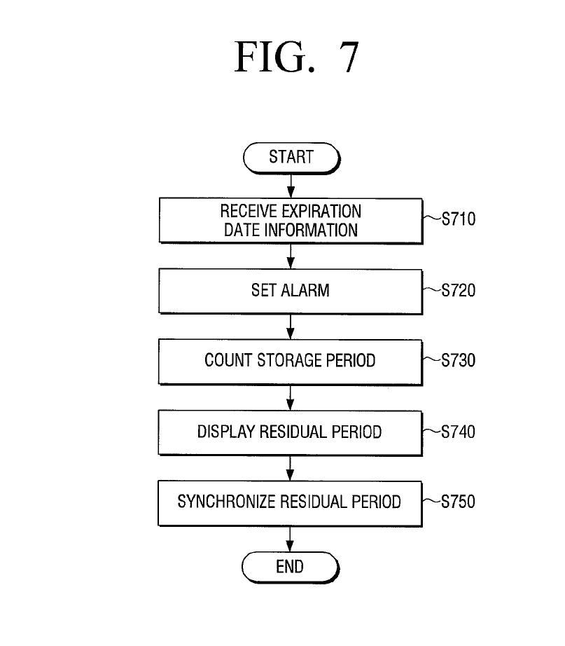

FIG. 7 is a flowchart illustrating an operation of a container, according to another exemplary embodiment of the present disclosure.

Referring to FIG. 7, in operation S710, the container receives period of time information. In detail, the container receives information about a period of time set by an external apparatus through a home server of a home network.

In operation S720, the container sets an alarm function. In detail, the container sets an alarm for informing a user of an arrival of the period of time.

In operation S730, the container counts a period for which food is stored, to the set period of time. In detail, the container counts a storage period through an operation of accumulating times as time elapses. In certain embodiments, the container performs an operation of subtracting an elapsed time from the set period of time to count the storage period.

In operation S740, the container displays a residual period. In detail, the container displays the residual period to the period of time to inform the user of a residual time to the set period of time.

In operation S750, the container synchronizes information about the residual period with a user terminal device. In detail, the container transmits a signal, which is to synchronize the user terminal device with information about the residual period, to the external apparatus so as to provide the same information to the user who recognizes the residual period.

The above-described process is not limited to the process of FIG. 7, and orders thereof are changed. Also, the counting of the period for which the food is stored continues after the period of time arrives. In certain embodiments, an excess period passing the period of time is displayed. If a particular event for sensing a request of the user or light of an illumination sensor occurs, the residual period is displayed. An operation of synchronizing the residual period of the food with the user terminal device is periodically performed.

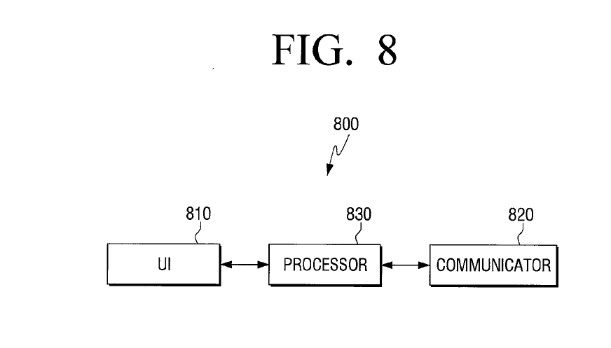

FIG. 8 is a block diagram illustrating a structure of a user terminal device 800 according to various embodiment of the present disclosure.

Referring to FIG. 8, the user terminal device 800 includes a user interface (UI) 810, a communicator 820, and a processor 830.

The UI 810 provides various types of screens for managing food of a container. In detail, the UI 810 displays the container to be managed and stored food information. The UI 810 also displays a storage period of food stored in the container, a residual period remaining to a set period of time, an excess period, or the like.

The UI 810 receives information for identifying the container. In detail, if the container to be managed is to be registered, the UI 810 receives information for identifying the corresponding container. For example, if a user puts food in the container to start storage of the food, storage information is received from the container, and a user terminal device provides a screen through which information for distinguishing the corresponding container from other containers is input. In certain embodiments, identification information that is input by the user is at least one selected from a name of the container, a name of stored food, a picture of the food, and a position in which the container is installed in a refrigerator.

The UI 810 receives an input for setting a period of time in the container. In detail, the user selects a container, which is registered as an object to be managed, and displays a screen for setting the period of time.

The UI 810 receives a command for resetting period information of the container. In detail, the UI 810 receives an input for initializing a counted storage period or initializing a set period of time, a residual period calculated based on the set period of time, or an excess period.

The communicator 820 communicates with various types of external apparatuses. In detail, the communicator 820 accesses a home server through a communication network to communicate with a container on a home network.

The communicator 820 access the home server through an LAN and the Internet or through a universal serial bus (USB) port. The communicator 820 transmits a control signal to at least one container 200 and receives data depending on the control signal from the container 200.

The communicator 820 includes various types of communication chips such as a WiFi chip, a BLUETOOTH chip, a near field communication (NFC) chip, a wireless communication chip, etc. In certain embodiments, the WiFi chip, the BLUETOOTH chip, and the NFC chip respectively perform communications according to a WiFi method, a BLUETOOTH method, and an NFC method. If the WiFi chip or the BLUETOOTH chip is used, the WiFi chip or the BLUETOOTH chip transmit or receive various types of connection information, such as a subsystem identification (SSID), a session key, etc., to connect a communication by using the various types of connection information so as to perform the communication. The wireless communication chip performs a communication according to various types of communication standards such as IEEE, ZIGBEE, 3^{rd} Generation (3G), a 3^{rd} Generation Partnership Project (3GPP), LTE, etc.

The processor 830 controls elements of the user terminal device 800. In detail, the processor 830 controls the elements of the user terminal device 800 to perform various functions for managing food of the container.

The processor 830 calculates food storage information of a container that is registered. In detail, the processor 830 calculates a storage period for which food is stored in each container, a residual period remaining to a set period, or an excess period passing the period of time.

If an input for selecting the container is received through the UI 810, the processor 830 provides a screen to display calculated period information.

If a reset command is input, the processor 830 initializes information related to storage of food. The processor 830 also controls the communicator 820 to transmit a signal for initializing to the container.

If information for setting a period of time is input, the processor 830 sets an alarm for informing the user of the period of time. The processor 830 also controls the communicator 820 to transmit the period of time to the container.

The processor 830 includes a CPU, a read only memory (ROM) that stores a control program for controlling the user terminal device 800, and a random access memory (RAM) that stores a signal or data input from an outside of the user terminal device 800 or is used as a memory area for a job performed by the user terminal device 800. The CPU includes at least one selected from a single core processor, a dual core processor, a triple core processor, and a quad core processor. The CPU, the ROM, and the RAM are connected to one another through an internal bus.

The user terminal device 800 described above is realized as a mobile device the user carries, and the control program is provided as a mobile application.

A user terminal device as described above provides information that synchronizes with a container and provides a means through which a user checks stored foods at a look and conveniently manages the stored foods.

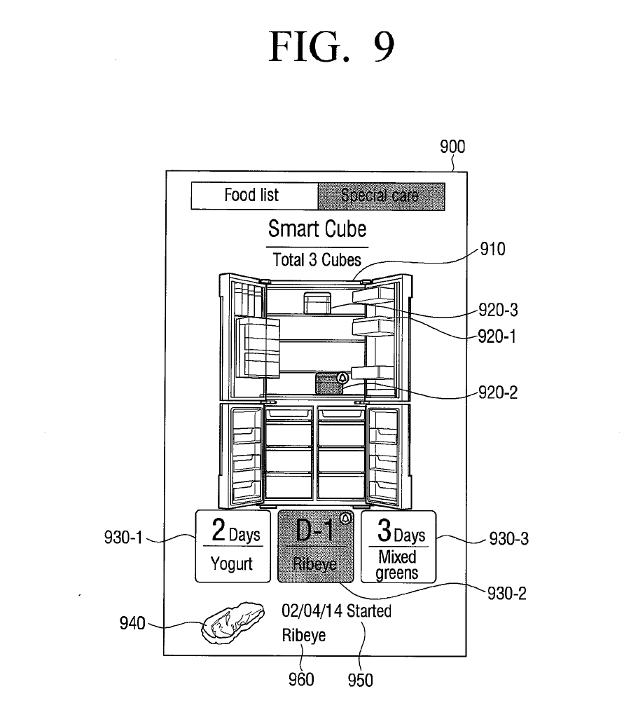

FIG. 9 is a view illustrating a screen 900 that is displayed on a user terminal device, according to various embodiment of the present disclosure.

Referring to FIG. 9, the screen 900 of the user terminal device includes a refrigerator 910 of a model that is used by a user, containers 920-1, 920-2, and 920-3, storage information 930-1, 930-2, and 930-3 of the containers 920-1, 920-2, and 920-3, a food picture 940, a storage start date 950, and a food name 960.

If the user terminal device executes an application for managing food, the screen 900 capable of managing food is displayed. The refrigerator 910 of used model input by the user is displayed, and the containers 920-1, 920-2, and 920-3 are displayed in positions of the refrigerator 910 where the containers 920-1, 920-2, and 920-3 are respectively installed.

The containers 920-1, 920-2, and 920-3 that are displayed are selected by the user. Also, the container 920-2 that is selected is highlighted in a different color from the other containers 920-1 and 920-3. A bell-shaped icon where an alarm is set overlaps with a part of the container 920-2 where a period of time is set.

The food storage information 930-1, 930-2, and 930-3 respectively corresponding to the containers 920-1, 920-2, and 920-3 that are displayed are provided in forms that are transversely scrolled. The food storage information 930-2 corresponding to the selected container 920-2 is moved to be disposed in center. The selected food storage information 930-2 is highlighted in a different color from the other food storage information 930-1 and 930-3.

Storage periods or residual periods are displayed on the food storage information 930-1, 930-2, and 930-3 that is displayed. Also, food names are displayed on the food storage information 930-1, 930-2, and 930-3 along with the storage periods or the residual periods. As shown in FIG. 9, yogurt that is stored for two days, a beef rib of which period of time is one day before, and mixed greens that are stored for three days are displayed.

Detailed information about the selected container 920-2 is displayed on a bottom of the screen 900. The detailed information includes the food picture 940, the storage start date 950, and the food name 960. A picture of beef rib, storage start date “2014, Feb. 4”, and food name “Ribeye” are displayed in FIG. 9.

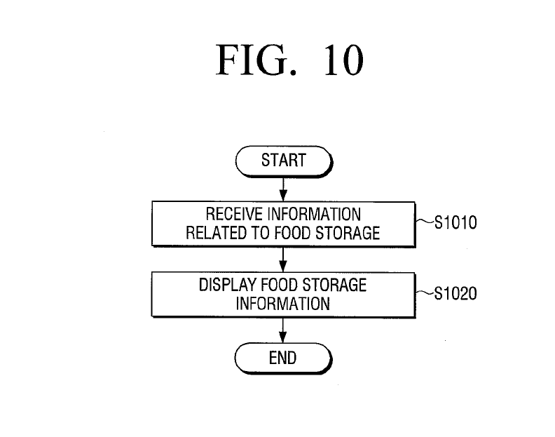

FIG. 10 is a flowchart illustrating a method of managing a container by using a user terminal device, according to various embodiment of the present disclosure.

Referring to FIG. 10, the user terminal device accesses a home server so as to start the method of managing the food. Alternatively, a user executes an application on the user terminal device so as to automatically perform the method.

In operation S1010, food storage-related information is received. In detail, the user terminal device accesses the home server through a home network to receive the food storage-related information from the container. Here, the food storage-related information includes at least one selected from storage start information, storage period information, reset information, and power on and/off information.

In operation s1020, the food storage-related information is displayed. In detail, the user terminal device displays a date where storage of food starts or information about a period for which food is stored, based on the received food storage-related information.

The method of managing the food further includes: receiving information for starting storage of food; and inputting identification information for identifying a new container in response to the received information.

The user terminal device displays at least one selected from a position of a storage room of a refrigerator where the container is installed, a name of the stored food, and a picture of the stored food, based on the input identification information.

The method further includes: receiving an input for setting a period of time on the user terminal device and transmitting the period to the container. In certain embodiments, a residual period or an excess period depending on the set period of time is displayed.

The method further includes: if a reset command is input, initializing information related to storage of food or transmitting a signal for initializing to the container.

The above-described method further conveniently and efficiently individually manages foods stored in the container, by using the user terminal device.

Also, the method of managing the food according to the exemplary embodiment of the present disclosure is embodied by the user terminal device 800 of FIG. 8. The method also is stored on various types of recording media to be embodied by a program code that is executed by a CPU or the like.

In detail, a code for performing the above-described methods is stored on various types of computer-readable recording media such as an RAM, an ROM, an erasable programmable ROM (EPROM), an electrically erasable and programmable ROM (EEPROM), a register, a hard disc, a removable disc, a memory card, a USB memory, a CD-ROM, etc.

FIG. 11 is a view illustrating a structure of a refrigerator 1100 according to various embodiment of the present disclosure.

Referring to FIG. 11, the refrigerator 1100 includes a communicator 1110 and a central controller 1130 and selectively further includes a UI 1120. For convenience of description, a container 200″, a home server 100, and a user terminal device 800′ are illustrated together in FIG. 11.

The refrigerator 1100 includes a space where a storage room 1150 and a machine room 1140 are separated from each other. Also, the communicator 1110, the UI 1120, and the central controller 1130 for managing the container 200″ re installed in the machine room 1140 of the refrigerator 1100. One container or a plurality of containers 200″-1, 200″-2, . . . , and 200″-N are respectively installed in spaces that are divided by selves in the storage room 1150.

The communicator 1110 performs communications. In detail, the communicator 1110 communicates with the containers 200″-1, 200″-2, . . . , and 200″-N.

The communicator 1110 communicates with the user terminal device 800′. In certain embodiments, the communicator 1110 directly communicates with the user terminal device 800′ or communicates with the user terminal device 800′ through the home server 100 that establishes a home network together with the refrigerator 1100.

The UI 1120 includes a function of the UI 810 of the user terminal device 800 of FIGS. 8 and 9. In detail, the UI 1120 provides food information for managing foods stored in the containers 200″-1, 200″-2, . . . , and 200″-N installed in the storage room 1150, storage periods of the foods, and various types of screens. For example, the UI 1120 visually displays installation positions of the containers 200″-1, 200″-2, . . . , and 200″-N that are monitored and lists and displays information about the foods stored in the containers 200″-1, 200″-2, . . . , and 200″-N, storage dates of the foods, storage periods of the foods, periods of time of the foods, etc.

The UI 1120 receives information for identifying the containers 200″-1, 200″-2, . . . , and 200″-N. In detail, the UI 1120 receives a registration or a deletion of a new container 200″, a name given to food stored in the new container 200″, an installation position of the new container 200″, or the like.

The UI 1120 receives a command for resetting period information of a container. In detail, the UI 1120 receives an input for initializing a counted storage period or initializing a set period of time and a residual period or an excess period calculated based the set period of time.

If functions as described above are completely performed by the user terminal device 800′ that performs communications, the UI 1120 of the refrigerator 1100 may not be included.

The central controller 1130 controls elements of the refrigerator 1100. In detail, the central controller 1130 controls the elements of the refrigerator 1100 to keep a temperature of food stored in the storage room 1150 of the refrigerator 1100 at a low temperature so as to greenly keep the food.

The central controller 1130 monitors the at least one container 200″ installed in the storage room 1150 through the communicator 1110. In detail, the central controller 1130 requests state information of the containers 200″-1, 200″-2, . . . , and 200″-N that are pre-installed. For example, the central controller 1130 requests identification information, a storage temperature, etc. of the container 200″. The central controller 1130 also determines that the new container 200″ is installed in the storage room 1150.

The central controller 1130 calculates information about storage periods of the container 200″-1, 200″-2, . . . , and 200″-N that are registered. In detail, the central controller 1130 performs operations of calculating storage periods of foods respectively stored in the containers 200″-1, 200″-2, . . . , and 200″-N to respectively manage the containers 200″-1, 200″-2, . . . , 200″-N that are registered and are objects to be monitored.

For example, if a storage start date is directly input from the UI 1120 or the user terminal device 800′ or the new container 200″ is registered, the central controller 1130 performs an operation of calculating a storage period from a storage start date.

Also, the central controller 1130 performs an operation of calculating a residual period or an excess period of the container 200″ of which period of time is set. In certain embodiments, periods of time are directly individually and respectively set on the containers 200″-1, 200″-2, . . . , 200″-N or are set by and received from the UI 1120 or the user terminal device 800′.

The central controller 1130 transmits information about foods respectively stored in the container 200″-1, 200″-2, . . . , and 200″-N. In detail, the central controller 1130 transmits information of foods corresponding to the containers 200″-1, 200″-2, . . . , and 200″-N so as to display food names, information about storage periods of foods, etc. on the container 200″-1, 200″-2, . . . , and 200″-N that are managed.

The central controller 1130 controls the communicator 1110 to transmit commands of the containers 200″-1, 200″-2, . . . , and 200″-N. In detail, the central controller 1130 transmits a command of each of the containers 200″-1, 200″-2, . . . , and 200″-N or commands of all of the containers 200″-1, 200″-2, . . . , and 200″-N.

For example, the central controller 1130 transmits a power-saving command for turning on display apparatuses of the containers 200″-1, 200″-2, . . . , and 200″-N if a door of the refrigerator 1100 is opened and turning off the display apparatuses if the door is closed. The central controller 1130 also transmits information about calculated storage periods corresponding to the containers 200″-1, 200″-2, . . . , and 200″-N. The central controller 1130 transmits a display command for displaying information about a residual period or an excess period of the container 200″ of which period of time is set or an alarm command for performing at least one selected from an emission of light informing the user of an arrival of the period of time and outputting of a sound. Also, the central controller 1130 transmits a power command for turning on or off the containers 200″-1, 200″-2, . . . , and 200″-N or a reset command for initializing information that is stored or set on the containers 200″-1, 200″-2, . . . , and 200″-N.

The central controller 1130 performs a process of connecting the communicator 1110 to at least one of the home server 100 and the user terminal device 800′. For example, the central controller 1130 performs a process of registering the refrigerator 1100 on the home server 100. The central controller 1130 also performs an authentication process of approving an access of the user terminal device 800′.

A refrigerator according to various embodiment of the present disclosure as described above configures a home network system to control a container that is installed in a storage room, so as to further easily manage food. Although the refrigerator is not opened, the refrigerator provides information about stored food. Also, the refrigerator possesses a higher performance than the container to perform operations and monitoring so as to enable stable communications and managements.

All elements constituting exemplary embodiments of the present disclosure are combined into one or are combined to operate but are not limited thereto. In other words, all elements are selectively combined into one or more to operate within the scope of the present disclosure. Also, each of all elements are realized as one independent piece of hardware but some or all of the elements are selectively combined to be realized as a computer program having a program module performing some or all of functions that are combined in one piece of hardware or a plurality of pieces of hardware. Codes and code segments constituting the computer program may be easily inferred by those skilled in the art. The computer program is stored on a non-transitory computer-readable media to be read and executed by a computer so as to embody exemplary embodiments of the present disclosure.

The non-transitory computer-readable medium refers to a medium which does not store data for a short time such as a register, a cache memory, a memory, or the like but semi-permanently stores data and is readable by a device. In detail, the above-described applications or programs is stored and provided on a non-transitory computer readable medium such as a CD, a DVD, a hard disk, a blue-ray disk, a universal serial bus (USB), a memory card, a ROM, or the like.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A container configured to include an internal space capable of storing food, the food container comprising:
a display unit configured to display a screen;
a communication interface configured to communicate with an external apparatus for managing the food container; and
a controller configured to control information regarding the food that is synchronized with the external apparatus through the communication interface to be displayed on the display unit.

2. The container of claim 1, wherein the information regarding the food comprises at least one selected from a name of the food, a picture of the food, a storage start time of the food, a period for which the food is stored in the food container, and a residual period of time set on the food container or an excess period passing a set time.

3. The container of claim 1, wherein the controller is further configured to display the information regarding the food received from the external apparatus on the display unit.

4. The container of claim 1, wherein the communication interface is further configured to communicate with a user terminal device,
wherein the controller is further configured to calculate a storage period of the food, display the storage period of the food on the display unit, and transmit information about the storage period of the food to the user terminal device.

5. The container of claim 1, further comprising:
a light emitter configured to emit light,
wherein the controller is further configured to control the light emitter to emit different colors of lights for a preset time period before and after an arrival time of a set expiration date.

6. The container of claim 1, further comprising:
a speaker configured to output a sound,
wherein the controller is further configured to control the speaker to output an alarm sound in response to a set expiration date arriving.

7. The container of claim 1, further comprising:
an input unit configured to receive a manipulation of a user,
wherein the controller is further configured to control power of the food container or initialize information regarding a storage period of the stored food according to a manipulation pattern input into the input unit.

8. The container of claim 1, further comprising:
an illumination sensor configured to sense light,
wherein the controller is further configured to control power of the display unit according to whether the illumination sensor senses the light.

9. The container of claim 1, further comprising:
a temperature sensor configured to sense a temperature; and
a duct configured to open and close an air flow path,
wherein the controller is further configured to control the duct to be opened and closed according to the sensed temperature.

10. The container of claim 1, wherein the controller is further configured to display at least one selected from information indicating a communicable state and information indicating a state where an expiration date is set on the display unit.

11. The container of claim 1, wherein the food container is installed as a container configured to store food to be kept at a low temperature in a storage room of a refrigerator,
wherein the external apparatus is the refrigerator where the food container is installed.

12. The container of claim 11, wherein the display unit is a transparent display that is a passive matrix type.

13. A refrigerator comprising:
a communicator configured to communicate with at least one food containers that are installed in the refrigerator; and
a central controller configured to control the communicator to transmit information about foods stored in the at least one food containers to the at least one food containers.

14. The refrigerator of claim 13, wherein the central controller is further configured to calculate storage periods of the foods stored in the at least one food containers and transmit the storage periods of the foods to the at least one food containers.

15. The refrigerator of claim 13, further comprising:
a user interface (UI),
wherein the central controller is further configured to display identification information regarding the at least one food containers and the information about the foods on the UI.

16. The refrigerator of claim 15, wherein the central controller is further configured to display at least one selected from information indicating a communicable state and information indicating a state where an expiration date is set on the UI.

17. The refrigerator of claim 13, wherein the communicator is further configured to communicate with a user terminal device,
wherein the controller is further configured to transmit the information about the foods to the user terminal device.

18. The refrigerator of claim 13, wherein the information about foods comprises at least one selected from a name of the food, a picture of the food, a storage start time of the food, a period for which the food is stored in the food container, and a residual period of time set on the food container or an excess period passing a set time.

19. A method of managing at least one food containers by using a user terminal device configured to manage the at least one food containers storing individual foods, the method comprising:
receiving food storage-related information from the food containers or a refrigerator where the food containers are installed; and
displaying food storage information regarding the food containers based on the received food storage-related information.

20. The method of claim 19, wherein the food storage-related information comprises at least one selected from a name of the food, a picture of the food, a storage start time of the food, a period for which the food is stored in the food container, and a residual period of time set on the food container or an excess period passing a set time.
